(19) United States
(12) Patent Application Publication
(10) Pub. No.: US 2007/0005167 A1
(43) Pub. Date: Jan. 4, 2007

(54) System and method for pro-active manufacturing performance management

(76) Inventors: George Roumeliotis, Menlo Park, CA (US); Jonathan Knight, San Mateo, CA (US); Meg Sharkey, San Francisco, CA (US)

Correspondence Address: WHITE & CASE LLP;PATENT DEPARTMENT, 1155 AVENUE OF THE AMERICAS, NEW YORK, NY, 10036, US

(21) Appl. No.: 11/173,120

(22) Filed: Jun. 30, 2005

(51) Int. Cl. G06F 19/00

(52) U.S. Cl. 700/97; 700/108

(57) ABSTRACT

A system and method of the present invention allows a user to monitor the production of a factory in real-time. The user inputs desired values for various performance metrics. Then an embodiment of the present invention analyzes manufacturing plans by directly accessing manufacturing planning software. Projections are calculated for each metric and the projections are compared to the desired values. A document is then created summarizing the desired values and the projections. The document may contain hyperlinks that enable a user to view details about any of the performance metrics. The document may also contain formatting that highlights various metrics for a variety of reasons, including the failure to meet a performance metric. The document also allows users to embed comments that are then forwarded to other users, as a means to allow collaboration from a plurality of users.

### FIELD OF THE INVENTION

The present invention relates to an apparatus and method for information processing. More specifically, the present invention relates to a process of pro-actively planning manufacturing schedules.

### BACKGROUND OF THE INVENTION

Businesses may manufacture products for eventual purchase by consumers or by other manufacturers. These products are often manufactured in a factory. It is desirable for a business to track the performance of its factories for many reasons. For example, a business may want to ensure that its products are being manufactured in the most efficient manner possible. A business may also want to ensure that neither too much of a product nor too little of a product is being manufactured for a particular time period.

A hypothetical business in the field of manufacturing may consist of one or more factories. The performance of these factories may be measured by one or more performance metrics. Exemplary performance metrics may include production volume; inventory levels; days of supply; overtime hours; forecast demand; order demand; production hours; order fulfillment rate; and numerous other measures of performance. The manufacturing organization may have periodic goals with respect to one or more of the manufacturing performance metrics or initiatives to improve one or more of the manufacturing performance metrics.

Increasing productivity, lowering manufacturing costs, and improving on-time performance are common concerns for most manufacturing plants and factories. With the increasing market pressure for rapid reaction to fluctuating demand, scheduling an efficient manufacturing process, which maximizes the utilization of various resources, and minimizes equipment changeovers and downtimes, has become increasingly challenging. Historically, problems relating to the planning of manufacturing schedules are resolved by skillful technicians and planners. The planning process of a manufacturing schedule typically requires a skillful planner to make various adjustments to the planning preferences to anticipate fluctuations in demand and/or unexpected events such as equipment failure and labor issues.

The operation of the factories is typically controlled by a manufacturing plan. The manufacturing plan controls which operations will be undertaken by the factory at a specific point in time. For example, the manufacturing plan may specify that X number of widget A are to be produced followed by Y number of widget B. Factories are trending towards the use of software-based manufacturing planning, known generally in the field as Enterprise Resource Planning Software (ERP) or Manufacturing Requirements Planning Software (MRP).

In the past, the only method to analyze the metrics involved the analysis of historical performance. For example, if a business wanted to ensure that the factory was prepared for the month of November 2005, it may analyze the performance of the factory in November 2004. It may also examine the performance in October 2004 and compare the performance to October 2005. The business could look at metrics to determine, for example, the number of units produced for a month, the amount of time the factory was in operation, and various other metrics, such as those described above. Then the business would be able to schedule the factory's duties for November 2005 to hopefully prepare the factory for increased sales in the holiday season. Then the business would modify the manufacturing plan to reflect the desired changes.

There are several problems with such a system. The timing of the data analysis is problematic. For various reasons, a month-to-month comparison of a factory may not be very informative. For example, many items are seasonal in nature. More ice cream is sold in the summer than in the winter, so comparing October performance to November is not always useful for an ice cream factory; the raw ingredients (such as fruit) of many food items have seasonal variations in cost; there is a seasonal component in automobile sales; etc. In addition, such comparisons are not always useful in a year-to-year basis. The performance of a factory may have drastically improved from 2004 to 2005 such that comparisons are rendered less useful than they otherwise could be. Or an additional factory may have opened or another factory may have closed, changing the workload of other factories.

In addition, there is no way for the organization to influence the outcome for the period being analyzed. The organization is able to determine what happened in the past and determine how any performance problems occurred. In such a manner, they may be able to fix future problems. However, the organization does not recognize any problems until they have occurred, thereby wasting time and resources until a potential problem is fixed.

It is desirable to have a system and method that enabled an organization to better track and forecast the performance of its factories, so as to monitor and improve the said performance, taking into account relevant data. It is also desirable for such information to be available as early as possible, to minimize wasted time and resources.

### BRIEF DESCRIPTION OF THE DRAWING FIGURES

The present invention will be understood more fully from the detailed description given below and from the accompanying drawings of various embodiments of the invention, which, however, should not be taken to limit the invention to the specific embodiments, but are for explanation and understanding only.

FIG. 1 is a flowchart illustrating the operation of an embodiment of the present invention; and

FIG. 2 is a block diagram illustrating the environment in which an embodiment of the present invention operates.

### DETAILED DESCRIPTION

In the following description, for purposes of explanation, numerous specific details are set forth to provide a thorough understanding of the present invention. It will be apparent, however, to one skilled in the art that these specific details may not be required to practice the present invention.

A method and system of the present invention allows an organization to monitor various performance metrics, make predictions based on the performance metrics, and modify manufacturing plans to result in a more efficient production.

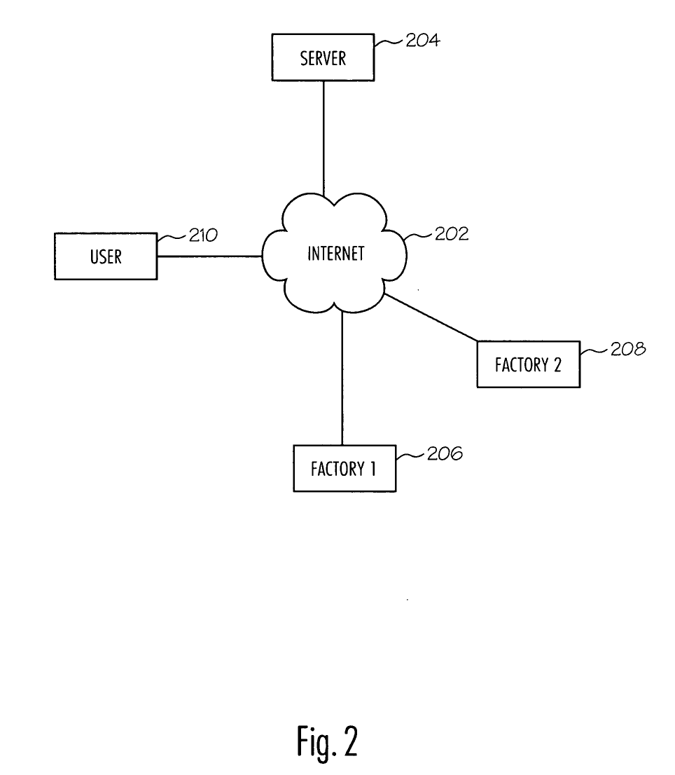

FIG. 2 is a block diagram showing the environment in which an embodiment of the present invention operates. A server 204 is accessible by entities such as user 210, first factory 206, and second factory 208. Each of the entities is coupled to a network, such as the Internet 202. It should be understood that any number of servers, users and factories may also be coupled to the Internet 202.

Server 204 may be configured in a variety of different manners known in the art. For example, server 204 may contain one or more storage units (such as hard drives, tape drives, or any other device now existing or developed in the future for storing data) and one or more processing units. An embodiment of the present invention may be located on storage unit contained in server 204. In such a situation, an embodiment of the present invention executes on a processing unit contained in server 204 to process data, then transmits data through Internet 202 to various users 210, and to factory 206 and factory 208.

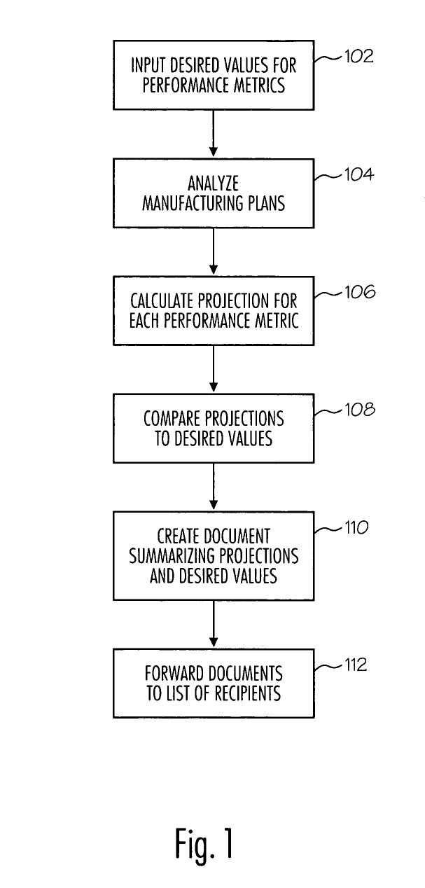

FIG. 1 is a flow-chart illustrating the operation of an embodiment of the present invention. At step 102, a user indicates desired values for one or more performance metrics. For example, a user may indicate that a goal of a particular factory is to produce 50,000 units of a specific item in a particular week. The user may also wish to ensure that inventory is kept below 5,000 units or to keep overtime hours below 5 per person. The various values desired by the user are entered into a “scorecard” that contains each of the goals set by the user.

The values may be entered in one of any of a variety of different manners. For example, in an embodiment utilizing a web browser interface, a user may enter desired values using a form accessible via a browser (such as Internet Explorer or Mozilla Firefox). In such an embodiment, a user would select a category from a pre-existing list for which a goal is to be set. The user would also be able to select the desired value or values.

At step 104, a system of the present invention analyzes the manufacturing plans to determine if the various goals established in step 102 will be met. An embodiment of the present invention interfaces directly with the ERP or MRP software to predict how many units will be produced and how much inventory will exist, how many man-hours will be used, and various other statistics that may be of interest to planners.

The analysis of manufacturing plan may take place in one of a variety of different manners. With reference to FIG. 2, in one embodiment, a manufacturing plan exists at factory 206, which uses manufacturing planning software to control its operations. The manufacturing plan is transferred from the factory 206 to a central server 204 via the Internet 202. This transfer may occur at regular, periodic intervals, such as daily or weekly. In the alternative or in addition, the transfer may occur whenever the manufacturing plan is changed.

An embodiment of the present invention is capable of reading the data from manufacturing plans in a variety of different formats, including spreadsheets, custom manufacturing planning software, and off-the-shelf manufacturing planning software. Such a feature is accomplished in the following manner. The manufacturing plan is transmitted from the manufacturing planning software at factory 206 via the Internet to server 204. The manufacturing plan is then translated into a predetermined format. The predetermined format may be a standard format, such as comma-delimited, XLS, and the like. The predetermined format may be a custom format now existing or developed in the future. The exact nature of the predetermined format is not important as long as an embodiment of the present invention is able to perform calculations based on the data. In an alternative embodiment, the translation to a predetermined format may occur at factory 206 before being transmitted to server 204. Server 204 then has the data from the manufacturing plan in a format that is usable by an embodiment of the present invention.

At step 106, a system of the present invention calculates a projection for each of the selected performance metrics, based on the data obtained from the manufacturing planning software. These calculations may occur in any manner now known or developed in the future.

At step 108, the projections are compared to the desired values established in step 102. The comparison occurs in any manner now known or developed in the future. For example, if the desired value is in the category of units produced, the comparison step will determine if the projected value is less than, equal to, or greater than the desired value.

At step 110, a document is created that contains a summary of the projections and the desired values. The document may be in one of a variety of different formats. In one embodiment of the present invention, the document supports hyperlinks, including, but not limited to, an HTML document. The document may be configured such that certain data is emphasized. For example, goals that were not attained can be differentiated by the use of a different font, have emphasis added to it (bold, underline, italic, etc.), or it may be in a different color. In another embodiment, multiple colors can be used to indicate the degree to which a goal was achieved or not achieved. For example, an achieved goal may be highlighted in green, while a projection that is within 2% of the goal may be highlighted in yellow, while a projection that is more than 2% from the goal may be highlighted in red. In an alternative embodiment, the document may only contain data related to the metrics that did not meet the goal. It should be understood that the present invention may create a document in any format now known or developed in the future.

At step 112, the document is forwarded to a predetermined list of recipients. The document may be forwarded via one of a variety of different methods. In one embodiment, the document is transmitted via Internet 202 using e-mail. In an alternative embodiment, the document may be placed in accessible location of server 204. Users are notified of the existence of the new document via e-mail, instant message, pager, voice mail, and any number of various notification methods now known or developed in the future. The user than accesses the document using a browser or browser-equivalent. In one embodiment, a list of recipients may be created at the time step 102 is completed. In an alternative embodiment, a list of recipients may be created at any time before step 112 occurs. For example, the user may create the list of recipients at step 102, when the user inputs the desired values for the various metrics.

In one aspect of the present invention, a user is able to add comments to the document generated in step 110. The comments are then forwarded to the distribution list, as described with respect to step 112. The comments may be attached to specific data elements. This attachment to specific data elements may occur in a variety of different manners. For example, a hyperlink may be created to link the comment to the specific data element.

The comments may be used in a variety of different manners. For example, if the desired value for units produced was to be 50,000 units and the projection based on data received from the manufacturing plans is only 44,000 units, a user may add a comment detailing reasons why the projection is short of that particular goal. In such a manner, the entire distribution list is aware of the specifics regarding each certain data elements.

In another aspect of the present invention, a user is able to view details regarding each item in the document. As mentioned above, the document created in step 1 10 may contain hyperlinks. The hyperlinks may be used to enable a user to view different information. For example, if the goal was to produce 50,000 units and the calculated projection is that only 44,000 units will be produced, the user may be able to click on a hyperlink, which provides access to details regarding the 44,000 units projected to be produced. The details may vary based on the type of data being accessed. But exemplary details may include a breakdown of data on a weekly, daily, or hourly basis. In addition, in a situation in which there are multiple factories, the user is able to determine the projection of each factory and access a breakdown of those details.

An embodiment of the present invention improves upon the prior art in a number of different ways. For example, because the notifications are sent before the production occurs, production schedules can be modified to ensure that the various goals are met. In comparison, the prior art only used past results-by that period of time, it could be too late to make up for any shortages of items, extraneous items, excessive overtime hours, and the like.

In the foregoing specification the invention has been described with reference to specific exemplary embodiments thereof. It will, however, be evident that various modifications and changes may be made thereto without departing from the broader scope of the invention. The specification and drawings are, accordingly, to be regarded in an illustrative rather than restrictive sense.

1. A method of monitoring production comprising:
inputting desired values with respect to one or more performance metrics;
obtaining data from a manufacturing planning software program;
calculating projections for each of said one or more performance metrics based on said data from a manufacturing planning software program;
comparing the projections for each said one or more metrics to each of said desired values; and
generating a document summarizing said desired values and said projections.

2. The method of claim I further comprising:
adding a comment to said document; and
forwarding the document with the comment to a predetermined list of recipients.

3. The method of claim 1 wherein said document contains hyperlinks to additional data, said additional data comprising details regarding individual metrics.

4. The method of claim 1 wherein said generating step further comprises adding emphasis to certain portions of said document to indicate specific information.

5. The method of claim 4 wherein said specific information includes a projection deviating from a desired value by more than a specified, pre-determined amount.

6. The method of claim I wherein said step of obtaining data comprises:
connecting to a remote computer system via the Internet;
obtaining manufacturing planning data from manufacturing planning software accessible on said remote computer system; and
translating said manufacturing planning data into a predetermined format.

7. The method of claim 6 wherein said manufacturing planning software comprises a spreadsheet.

8. The method of claim 6 wherein said manufacturing planning software comprises software specific to the creation of plans for use in manufacturing.

9. The method of claim 1 further comprising forwarding said document to a predetermined list of recipients.

10. The method of claim 9 wherein said predetermined list of recipients is created at said inputting step.

11. The method of claim 9 wherein said forwarding step comprises sending a message containing said document to said predetermined list of recipients via the Internet.

12. The method of claim 9 wherein said forwarding step comprises sending a message containing a hyperlink to said document to said predetermined list of recipients.
